(19) United States
(12) Patent Application Publication
(10) Pub. No.: US 2023/0042682 A1
(43) Pub. Date: Feb. 9, 2023

(54) AUTONOMOUS MOBILE BODY, INFORMATION PROCESSING METHOD, PROGRAM, AND INFORMATION PROCESSING DEVICE

(71) Applicant: SONY GROUP CORPORATION, TOKYO (JP)

(72) Inventors: KEI TAKAHASHI, TOKYO (JP); YOSHIHIDE FUJIMOTO, TOKYO (JP); JUNICHI NAGAHARA, TOKYO (JP)

(21) Appl. No.: 17/759,025

(22) PCT Filed: Jan. 8, 2021
(86) PCT No.: PCT/JP2021/000488

§ 371 Date: Jul. 18, 2022

(30) Foreign Application Priority Data
Jan. 24, 2020 (JP) 2020-009701

(51) Int. Cl. G05D 1/00

(52) U.S. Cl. CPC G05D 1/0088; G05D 1/0094; G05D 2201/02

(57) ABSTRACT

The present technology relates to an autonomous mobile body, an information processing method, a program, and an information processing device, by which a user experience based on an output sound of the autonomous mobile body can be improved. The autonomous mobile body includes a recognition section that recognizes a paired device that is paired with the autonomous mobile body, and a sound control section that changes a control method for an output sound to be outputted from the autonomous mobile body, on the basis of a recognition result of the paired device, and controls the output sound in accordance with the changed control method. The present technology is applicable to a robot, for example.

### TECHNICAL FIELD

The present technology relates to an autonomous mobile body, an information processing method, a program, and an information processing device, and particularly, relates to an autonomous mobile body, an information processing method, a program, and an information processing device, by which a user experience based on an output sound of an autonomous mobile body is improved.

### BACKGROUND ART

A technology of deciding the feeling status of a robot in response to a user's approach, selecting an action and a speech according to the decided feeling from performance information suited for an exterior unit mounted on the robot, and producing an autonomous motion of the robot using the selected action and speech has conventionally been proposed (for example, see PTL 1) .

### Citation List

### Patent Literature

[PTL 1] Japanese Patent Laid-open No. 2001-191275

### SUMMARY

### Technical Problem

In the invention disclosed in PTL 1, however, only preregistered fixed sounds are switched according to the exterior unit mounted on the robot, so that there has been a lack of variation.

The present technology has been achieved in view of the abovementioned circumstance. With the present technology, a user experience based on an output sound of an autonomous mobile body such as a robot is improved.

### Solution to Problem

An autonomous mobile body according to one aspect of the present technology includes a recognition section that recognizes a paired device that is paired with the autonomous mobile body, and a sound control section that changes a control method for an output sound to be outputted from the autonomous mobile body, on the basis of a recognition result of the paired device, and controls the output sound in accordance with the changed control method.

An information processing method according to one aspect of the present technology includes recognizing a paired device that is paired with an autonomous mobile body, changing a control method for an output sound to be outputted from the autonomous mobile body, on the basis of the recognition result of the paired device, and controlling the output sound in accordance with the changed control method.

A program according to the one aspect of the present technology causes a computer to execute processes of recognizing a paired device that is paired with an autonomous mobile body, changing a control method for an output sound to be outputted from the autonomous mobile body, on the basis of the recognition result of the paired device, and controlling the output sound in accordance with the changed control method.

An information processing device according to the one aspect of the present technology includes a recognition section that recognizes a paired device that is paired with an autonomous mobile body, and a sound control section that changes a control method for an output sound to be outputted from the autonomous mobile body, on the basis of the recognition result of the paired device, and controls the output sound in accordance with the changed control method.

According to the one aspect of the present technology, a paired device that is paired with the autonomous mobile body is recognized, and a control method for an output sound to be outputted from the autonomous mobile body is changed, on the basis of the recognition result of the paired device, and the output sound is controlled in accordance with the changed control method.

### BRIEF DESCRIPTION OF DRAWINGS

FIG. 1 is a block diagram depicting one embodiment of an information processing system to which the present technology is applied.

FIG. 2 is a front view of an autonomous mobile body.

FIG. 3 is a rear view of the autonomous mobile body.

FIG. 4 illustrates perspective views of the autonomous mobile body.

FIG. 5 is a side view of the autonomous mobile body.

FIG. 6 is a top view of the autonomous mobile body.

FIG. 7 is a bottom view of the autonomous mobile body.

FIG. 8 is a schematic diagram for explaining an internal structure of the autonomous mobile body.

FIG. 9 is a schematic diagram for explaining an internal structure of the autonomous mobile body.

FIG. 10 is a block diagram depicting a functional configuration example of the autonomous mobile body.

FIG. 11 is a block diagram depicting a functional configuration example implemented by a control section of the autonomous mobile body.

FIG. 12 is a diagram for explaining parameters concerning a synthesized sound.

FIG. 13 is a diagram depicting one example of a feeling that can be expressed as a result of pitch and speed control.

FIG. 14 is a block diagram depicting a functional configuration example of an information processing server.

FIG. 15 is a flowchart for explaining a motion mode deciding process which is executed by the autonomous mobile body.

FIG. 16 is a flowchart for explaining a basic example of a motion sound output control process which is executed by the autonomous mobile body.

FIG. 17 is a diagram depicting a specific example of a method for generating a motion sound from sensor data.

FIG. 18 illustrates diagrams depicting examples of sensor data obtained by a touch sensor and a waveform of a contact sound.

FIG. 19 is a flowchart for explaining a translational sound output control process during a normal mode.

FIG. 20 illustrates diagrams depicting examples of a translational sound waveform during the normal mode.

FIG. 21 is a flowchart for explaining a translational sound output control process during a cat mode.

FIG. 22 illustrates diagrams depicting examples of a translational sound waveform during the cat mode.

FIG. 23 is a flowchart for explaining a pickup sound output control process.

FIG. 24 is a diagram depicting a configuration example of a computer.

### DESCRIPTION OF EMBODIMENTS

Hereinafter, embodiments for carrying out the present technology will be explained. The explanation will be given in the following order.
1. Embodiment
2. Modifications
3. Others

### 1. Embodiment

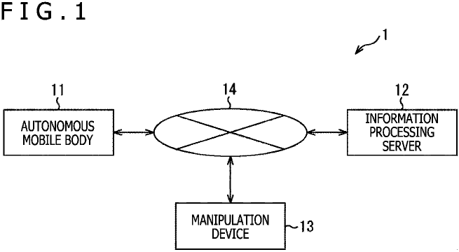

An embodiment according to the present technology will be explained with reference to FIGS. 1 to 23.

### Configuration Example of Information Processing System 1

FIG. 1 depicts one embodiment of an information processing system 1 to which the present technology is applied.

The information processing system 1 includes an autonomous mobile body 11, an information processing server 12, and a manipulation device 13. The autonomous mobile body 11, the information processing server 12, and the manipulation device 13 are connected to one another over a network 14.

The autonomous mobile body 11 is an information processing device that autonomously moves without control of the information processing server 12 or with control of the information processing server 12. For example, the autonomous mobile body 11 includes any type of a robot such as a running type, a walking type, a flying type, or a swimming type.

In addition, the autonomous mobile body 11 is an agent device capable of more naturally and effectively communicating with a user. One feature of the autonomous mobile body 11 is to actively execute a variety of motions (hereinafter, also referred to as inducing motions) for inducing communication with a user.

For example, the autonomous mobile body 11 is capable of actively presenting information to a user on the basis of environment recognition. Further, for example, the autonomous mobile body 11 actively executes a variety of inducing motions for inducing a user to execute a predetermined action.

In addition, an inducing motion executed by the autonomous mobile body 11 can be regarded as an active and positive interference with a physical space. The autonomous mobile body 11 can travel in a physical space and execute a variety of physical actions with respect to a user, a living being, an object, etc. According to these features of the autonomous mobile body 11, a user can comprehensively recognize a motion of the autonomous mobile body through the visual, auditory, and tactile sense. Accordingly, advanced communication can be performed, compared to a case where only voice is used to perform an interaction with a user.

Moreover, the autonomous mobile body 11 is capable of communicating with a user or another autonomous mobile body by outputting an output sound. Examples of the output sound of the autonomous mobile body 11 include a motion sound that is outputted according to a condition of the autonomous mobile body 11 and a speech sound used for communication with a user, another autonomous mobile body, or the like.

Examples of the motion sound include a sound that is outputted in response to a motion of the autonomous mobile body 11 and a sound that is outputted in response to a stimulus to the autonomous mobile body 11. Examples of the sound that is outputted in response to a motion of the autonomous mobile body 11 include not only a sound that is outputted in a case where the autonomous mobile body 11 actively moves, but also a sound that is outputted in a case where the autonomous mobile body 11 is passively moved. The stimulus to the autonomous mobile body 11 is a stimulus to any one of the five senses (visual sense, auditory sense, olfactory sense, gustatory sense, and tactile sense) of the autonomous mobile body 11, for example. It is to be noted that the autonomous mobile body 11 does not necessarily recognize all of the five senses.

The speech sound does not need to express a language understandable to human beings and may be a non-verbal sound imitating an animal's sound, for example.

The information processing server 12 is an information processing device that controls a motion of the autonomous mobile body 11. For example, the information processing server 12 has a function for causing the autonomous mobile body 11 to execute a variety of inducing motions for inducing communication with a user.

The manipulation device 13 is any type of a device that is manipulated by the autonomous mobile body 11 and the information processing server 12. The autonomous mobile body 11 can manipulate any type of the manipulation device 13 without control of the information processing server 12 or with control of the information processing server 12. For example, the manipulation device 13 includes a household electric appliance such as an illumination device, a game machine, or a television device.

The network 14 has a function of establishing connection between the devices in the information processing system 1. For example, the network 14 may include a public line network such as the Internet, a telephone line network, or a satellite communication network, various types of LANs (Local Area Networks) including Ethernet (registered trademark), and a WAN (Wide Area Network). For example, the network 14 may include a dedicated line network such as IP-VPN (Internet Protocol-Virtual Private Network). For example, the network 14 may include a wireless communication network such as Wi-Fi (registered trademark) or Bluetooth (registered trademark).

### Configuration Example of Autonomous Mobile Body 11

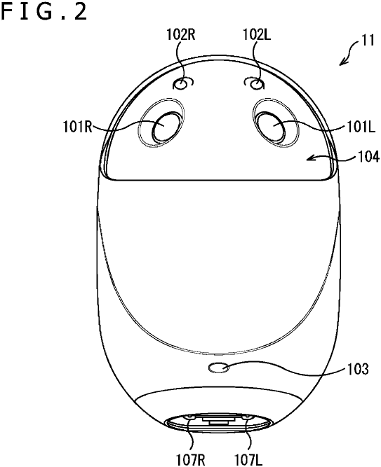

Next, a configuration example of the autonomous mobile body 11 will be explained with reference to FIGS. 2 to 13. The autonomous mobile body 11 can be any type of a device that executes an autonomous motion based on environment recognition. Hereinafter, a case in which the autonomous mobile body 11 is an agent-type robot device that has an elliptic shape and autonomously travels using wheels will be explained. The autonomous mobile body 11 performs a variety of types of communication including providing information through an autonomous motion according to a condition of a user state, a condition of the surrounding area, and a condition of the autonomous mobile body 11 itself, for example. The autonomous mobile body 11 is a compact robot having such size and weight as to easily be picked up by one hand of a user, for example.

### Example Of Exterior of Autonomous Mobile Body 11

First, an example of the exterior of the autonomous mobile body 11 will be explained with reference to FIGS. 2 to 7.

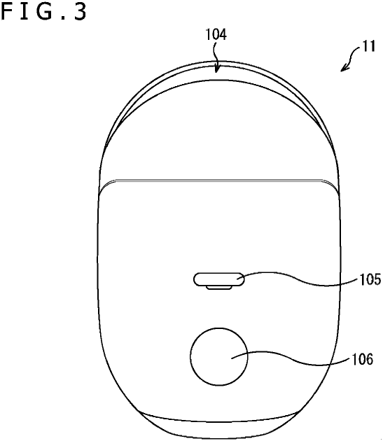

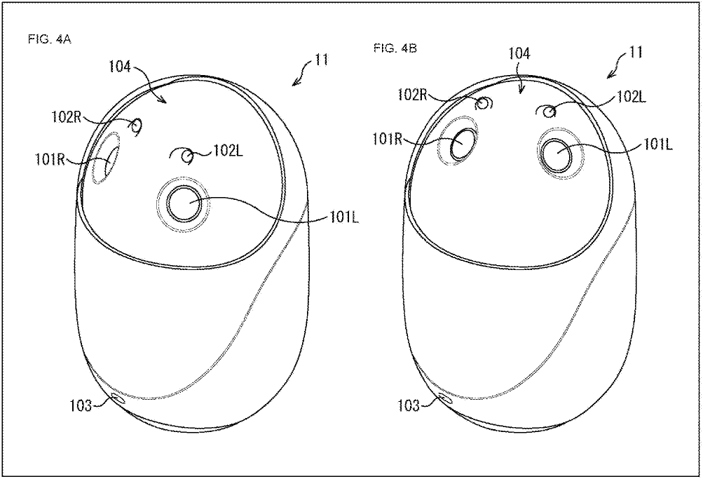

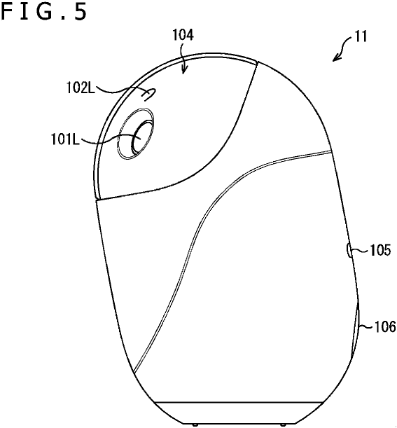

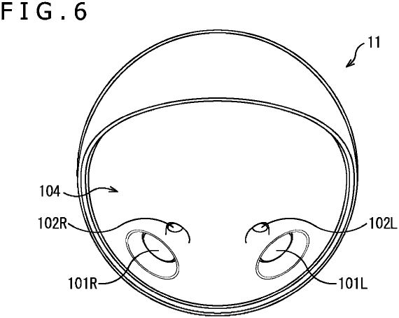

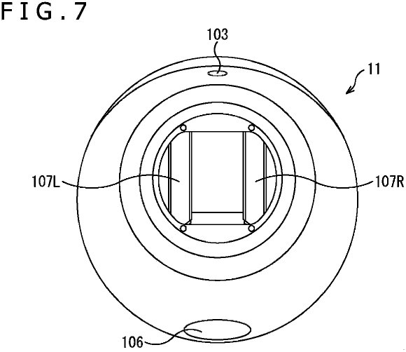

FIG. 2 is a front view of the autonomous mobile body 11. FIG. 3 is a rear view of the autonomous mobile body 11. In FIG. 4, A and B are perspective views of the autonomous mobile body 11. FIG. 5 is a side view of the autonomous mobile body 11. FIG. 6 is a top view of the autonomous mobile body 11. FIG. 7 is a bottom view of the autonomous mobile body 11.

As depicted in FIGS. 2 to 6, the autonomous mobile body 11 includes, on the upper portion of the main body thereof, an eye section 101L and an eye section 101R that correspond to a left eye and a right eye, respectively. The eye section 101L and the eye section 101R are realized by LEDs, for example, and can express a line of sight, winking, etc. It is to be noted that examples of the eye section 101L and the eye section 101R are not limited to the abovementioned ones. The eye section 101L and the eye section 101R may be realized by a single or two independent OLEDs (Organic Light Emitting Diodes), for example.

In addition, the autonomous mobile body 11 includes a camera 102L and a camera 102R above the eye section 101L and the eye section 101R. The camera 102L and the camera 102R each have a function of imaging a user and the surrounding environment. The autonomous mobile body 11 may perform SLAM (Simultaneous Localization and Mapping) on the basis of images captured by the camera 102L and the camera 102R.

It is to be noted that the eye section 101L, the eye section 101R, the camera 102L, and the camera 102R are disposed on a substrate (not depicted) that is provided on the inner side of the exterior surface. Further, the exterior surface of the autonomous mobile body 11 is basically made from an opaque material, but portions, of the exterior surface, corresponding to the substrate on which the eye section 101L, the eye section 101R, the camera 102L, and the camera 102R are disposed, are equipped with a head cover 104 made from a transparent or translucent material. Accordingly, a user can recognize the eye section 101L and the eye section 101R of the autonomous mobile body 11, and the autonomous mobile body 11 can image the outside.

Further, as depicted in FIGS. 2, 4, and 7, the autonomous mobile body 11 includes a ToF (Time of Flight) sensor 103 on the lower portion of the front side thereof. The ToF sensor 103 has a function of detecting the distance to an object that is present up ahead. With the ToF sensor 103, the autonomous mobile body 11 can detect the distance to any object with high accuracy and detect irregularities, so that the autonomous mobile body 11 can be prevented from falling or being turned over.

Further, as depicted in FIGS. 3 and 5, the autonomous mobile body 11 includes, on the rear surface thereof, a connection terminal 105 for an external device and a power supply switch 106. The autonomous mobile body 11 can perform information communication by being connected to an external device via the connection terminal 105, for example.

Further, as depicted in FIG. 7, the autonomous mobile body 11 includes a wheel 107L and a wheel 107R on the bottom surface thereof. The wheel 107L and the wheel 107R are driven by respectively different motors (not depicted). Accordingly, the autonomous mobile body 11 can implement a moving motion such as traveling forward and rearward, turning, and rotating.

In addition, the wheel 107L and the wheel 107R can be stored inside the main body and can be projected to the outside. For example, the autonomous mobile body 11 can make a jump by vigorously projecting the wheel 107L and the wheel 107R to the outside. It is to be noted that FIG. 7 depicts a state in which the wheel 107L and the wheel 107R are stored inside the main body.

It is to be noted that, hereinafter, the eye section 101L and the eye section 101R are simply referred to as the eye sections 101 if it is not necessary to distinguish these eye sections from each other. Hereinafter, the camera 102L and the camera 102R are simply referred to as the cameras 102 if it is not necessary to distinguish these cameras from each other. Hereinafter, the wheel 107L and the wheel 107R are simply referred to as the wheels 107 if it is not necessary to distinguish these wheels from each other.

### Example of Internal Structure of Autonomous Mobile Body 11

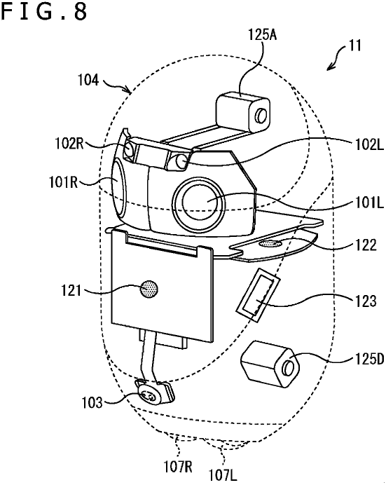

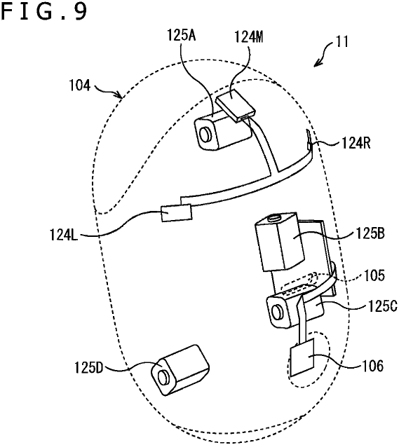

FIGS. 8 and 9 are schematic diagrams each depicting the internal structure of the autonomous mobile body 11.

As depicted in FIG. 8, the autonomous mobile body 11 includes an inertial sensor 121 and a communication device 122 disposed on an electric substrate. The inertial sensor 121 detects acceleration or an angular velocity of the autonomous mobile body 11. In addition, the communication device 122 is a section for performing wireless communication with the outside and includes a Bluetooth or Wi-Fi antenna, for example.

In addition, the autonomous mobile body 11 includes a loudspeaker 123 inside a side surface of the main body, for example. The autonomous mobile body 11 is capable of outputting a variety of sounds through the loudspeaker 123.

Further, as depicted in FIG. 9, the autonomous mobile body 11 includes a microphone 124L, a microphone 124M, and a microphone 124R on the inner side of the upper portion of the main body. The microphone 124L, the microphone 124M, and the microphone 124R collect a user speech and an environmental sound from the surrounding area. In addition, since a plurality of the microphones 124L, 124M, and 124R is provided, the autonomous mobile body 11 can collect a sound generated in the surrounding area with high sensitivity and detect the position of the sound source.

Furthermore, as depicted in FIGS. 8 and 9, the autonomous mobile body 11 includes motors 125A to 125E (though the motor 125E is not depicted in the drawings). The motor 125A and the motor 125B vertically and horizontally drive a substrate on which the eye section 101 and the camera 102 are disposed, for example. The motor 125C implements a forward tilt attitude of the autonomous mobile body 11. The motor 125D drives the wheel 107L. The motor 125E drives the wheel 107R. With the motors 125A to 125E, motion expression of the autonomous mobile body 11 can be enriched.

It is to be noted that, hereinafter, the microphones 124L to 124R are simply referred to as the microphones 124, if it is not necessary to distinguish these microphones from each other. Hereinafter, the motors 125A to 125E are simply referred to as the motors 125, if it is not necessary to distinguish these motors from each other.

### Functional Configuration Example of Autonomous Mobile Body 11

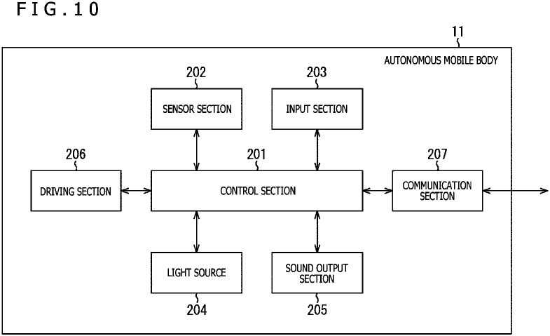

FIG. 10 depicts a functional configuration example of the autonomous mobile body 11. The autonomous mobile body 11 includes a control section 201, a sensor section 202, an input section 203, a light source 204, a sound output section 205, a driving section 206, and a communication section 207.

The control section 201 has a function of controlling the sections included in the autonomous mobile body 11. The control section 201 performs control to start and stop these sections, for example. In addition, the control section 201 supplies a control signal or the like received from the information processing server 12 to the light source 204, the sound output section 205, and the driving section 206.

The sensor section 202 has a function of collecting various types of data regarding a user and the surrounding condition. For example, the sensor section 202 includes the abovementioned cameras 102, the ToF sensor 103, the inertial sensor 121, the microphones 124, etc. In addition, the sensor section 202 may further include sensors including a humidity sensor, a temperature sensor, and various types of optical sensors such as an IR (infrared) sensor, a touch sensor, and a geomagnetic sensor in addition to the described sensors. The sensor section 202 supplies sensor data outputted from the sensors to the control section 201.

The input section 203 includes buttons and switches including the abovementioned power supply switch 106, for example, and detects a physical input manipulation performed by a user.

The light source 204 includes the abovementioned eye sections 101, for example, and expresses eyeball motions of the autonomous mobile body 11.

The sound output section 205 includes the abovementioned loudspeaker 123 and an amplifier, for example, and outputs an output sound on the basis of output sound data supplied from the control section 201.

The driving section 206 includes the abovementioned wheels 107 and motors 125, for example, and is used to express a body motion of the autonomous mobile body 11.

The communication section 207 includes the abovementioned connection terminal 105 and communication device 122, for example, and communicates with the information processing server 12, the manipulation device 13, and any other external devices. For example, the communication section 207 transmits sensor data supplied from the sensor section 202 to the information processing server 12, and receives, from the information processing server 12, a control signal for controlling a motion of the autonomous mobile body 11 and output sound data for outputting an output sound from the autonomous mobile body 11.

### Configuration Example of Information Processing Section 241

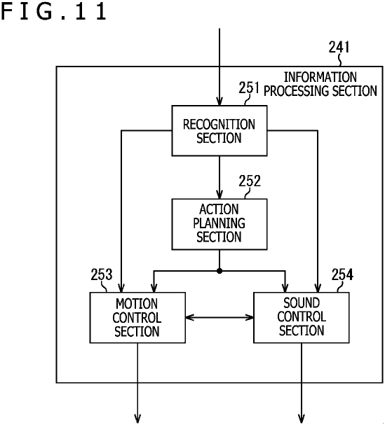

FIG. 11 depicts a configuration example of an information processing section 241 that is implemented by the control section 201 of the autonomous mobile body 11 executing a predetermined control program.

The information processing section 241 includes a recognition section 251, an action planning section 252, a motion control section 253, and a sound control section 254.

The recognition section 251 has a function of recognizing a user and an environment around the autonomous mobile body 11 and a variety of types of information concerning the autonomous mobile body 11 on the basis of sensor data supplied from the sensor section 202.

For example, the recognition section 251 recognizes a user, the facial expression or visual line of the user, an object, a color, a shape, a marker, an obstacle, irregularities, the brightness, a stimulus to the autonomous mobile body 11, etc. For example, the recognition section 251 recognizes a feeling according to a user's voice, comprehends words, and recognizes the position of a sound source. For example, the recognition section 251 recognizes the ambient temperature, the presence of a moving object, and the posture or a motion of the autonomous mobile body 11. For example, the recognition section 251 recognizes a device (hereinafter, referred to as a paired device) that is paired with the autonomous mobile body 11.

As examples of pairing of the autonomous mobile body 11 with a paired device, a case where either one of the autonomous mobile body 11 and the paired device is attached to the other, a case where either one of the autonomous mobile body 11 and the paired device is mounted on the other, a case where the autonomous mobile body 11 and the paired device are joined together, etc., are assumed. In addition, examples of the paired device include a part (hereinafter, referred to as an optional part) that is attachable to and detachable from the autonomous mobile body 11, a mobile body (hereinafter, referred to as a mobile body for mounting) on which the autonomous mobile body 11 can be mounted, and a device (hereinafter, referred to as an attachment destination device) to/from which the autonomous mobile body 11 can be attached/detached.

A part modeling an animal body part (e.g., eye, ear, nose, mouth, beak, horn, tail, wing), an outfit, a character costume, a part (e.g., medal, armor) for extending a function or ability of the autonomous mobile body 11, wheels, and caterpillars are assumed as examples of the optional part. A vehicle, a drone, and a robotic vacuum cleaner are assumed as examples of the mobile body for mounting. An assembled robot including a plurality of parts including the autonomous mobile body 11 are assumed as examples of the attachment destination device.

It is to be noted that the paired device does not need to be one dedicated to the autonomous mobile body 11. For example, a generally usable device may be used therefor.

In addition, the recognition section 251 has a function of inferring an environment or condition of the autonomous mobile body 11 on the basis of recognized information. When implementing this function, the recognition section 251 may generally infer the condition by using previously-saved environment knowledge.

The recognition section 251 supplies data indicating the recognition result to the action planning section 252, the motion control section 253, and the sound control section 254.

The action planning section 252 decides a motion mode for defining a motion of the autonomous mobile body 11 on the basis of a recognition result obtained by the recognition section 251, or a recognition result of a paired device recognized by the recognition section 251, for example. In addition, the action planning section 252 has a function of planning an action to be executed by the autonomous mobile body 11, on the basis of the recognition result, the motion mode, and learned knowledge obtained by the recognition section 251, for example. Furthermore, the action planning section 252 carries out the action plan by using a machine learning algorithm of deep learning, for example. The action planning section 252 supplies motion data and data indicating the action plan to the motion control section 253 and the sound control section 254.

The motion control section 253 performs motion control of the autonomous mobile body 11 by controlling the light source 204 and the driving section 206 on the basis of the recognition result supplied by the recognition section 251, the action plan supplied by the action planning section, and the motion mode. For example, the motion control section 253 causes a forward/rearward motion, a turning motion, a rotating motion, etc., of the autonomous mobile body 11 while keeping the forward tilt attitude of the autonomous mobile body 11. In addition, the motion control section 253 causes the autonomous mobile body 11 to actively execute an inducing motion for inducing communication between a user and the autonomous mobile body 11. In addition, the motion control section 253 supplies information regarding a motion being executed by the autonomous mobile body 11 to the sound control section 254.

The sound control section 254 controls an output sound by controlling the sound output section 205 on the basis of a recognition result supplied by the recognition section 251, an action plan supplied by the action planning section 252, and the motion mode. For example, the sound control section 254 decides a control method for the output sound on the basis of the motion mode or the like and controls the output sound (for example, controls an output sound to be generated and an output timing of the output sound) in accordance with the decided control method. Then, the sound control section 254 generates output sound data for outputting the output sound and supplies the output sound data to the sound output section 205. Further, the sound control section 254 supplies information regarding an output sound being outputted from the autonomous mobile body 11 to the motion control section 253.

### Method of Generating Synthesized Sound

Next, a method of generating a synthesized sound at the sound control section 254 will be explained.

The sound control section 254 generates an output sound including a synthesized sound by using an FM sound source, for example. In this case, the sound control section 254 changes the waveform of the synthesized sound, that is, the pitch (musical pitch, musical note), the volume, the tone color, the speed, etc., of the synthesized sound by dynamically and constantly changing parameters concerning synthesis of the FM sound source, so that the impression and the feeling meanings of the synthesized sound can be expressed in a variety of forms.

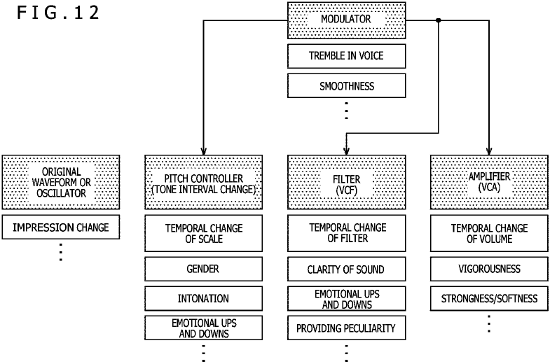

FIG. 12 is a diagram for explaining parameters concerning a synthesized sound. In FIG. 12, the relation between each section included in a synthesizer for synthesizing an FM sound source and an output form that is expressed by a synthesized sound based on variation of parameters concerning the respective sections is illustrated.

The sound control section 254 can vary a basic sound feeling by varying a parameter concerning an oscillator, for example. In one example, the sound control section 254 can express a soft impression by using a sine wave as the sound waveform, and can express a sharp impression by forming the sound waveform into a saw-toothed shape.

In addition, the sound control section 254 can express the difference in gender, an intonation, emotional ups and downs, etc., by controlling a parameter concerning a pitch controller, that is, controlling a pitch, for example.

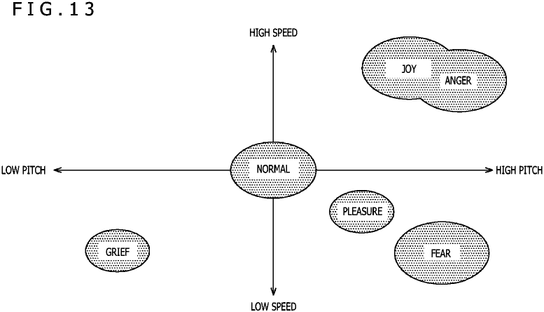

FIG. 13 is a diagram depicting one example of a feeling that can be expressed as a result of sound pitch and sound speed control. It is to be noted that the size (area) of a hatched region in FIG. 13 indicates a volume. It has been known that the pitch or speed of a sound has a great influence on memorability of a feeling expressed by the sound. The sound control section 254 can express a degree of joy or anger by setting relatively high pitch and speed, for example. In contrast, the sound control section 254 can express sadness and grief by setting relatively low pitch and speed. In such a manner, the sound control section 254 can express a variety of feelings and the degree thereof by controlling the sound pitch and the sound speed.

Referring back to FIG. 12, the sound control section 254 can express a sound clarity (a way of opening the mouth) by controlling a parameter concerning a filter. For example, the sound control section 254 can express a muffled voice and a clear sound by increasing and decreasing the frequency of a high-cut filter.

In addition, the sound control section 254 can vary an accent of the volume and an impression of activating the sound start or stopping the sound by using temporal variation of the amplifier.

In addition, the sound control section 254 can express a trembling voice and a smooth voice by controlling a parameter concerning the modulator.

By varying the parameters concerning the oscillator, the modulator, the pitch controller, the filter, and the amplifier in such a manner, the sound control section 254 can express a variety of impressions and emotional meanings.

### Functional Configuration Example of Information Processing Server 12

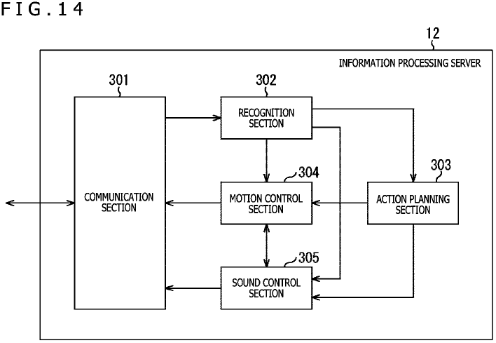

FIG. 14 depicts a functional configuration example of the information processing server 12.

The information processing server 12 includes a communication section 301, a recognition section 302, an action planning section 303, a motion control section 304, and a sound control section 305.

The communication section 301 communicates with the autonomous mobile body 11 and the manipulation device 13 over the network 14. For example, the communication section 301 receives sensor data from the autonomous mobile body 11, and transmits, to the autonomous mobile body 11, a control signal for controlling a motion of the autonomous mobile body 11 and output sound data for outputting an output sound from the autonomous mobile body 11.

Functions of the recognition section 302, the action planning section 303, the motion control section 304, and the sound control section 305 are similar to those of the recognition section 251, the action planning section 252, the motion control section 253, and the sound control section 254 of the autonomous mobile body 11, respectively. That is, the recognition section 302, the action planning section 303, the motion control section 304, and the sound control section 305 can perform processes in place of the recognition section 251, the action planning section 252, the motion control section 253, and the sound control section 254 of the autonomous mobile body 11.

Accordingly, the information processing server 12 can remotely control the autonomous mobile body 11, and the autonomous mobile body 11 can execute a variety of motions and output a variety of output sounds under control of the information processing server 12.

### Processes in Autonomous Mobile Body 11

Next, processes in the autonomous mobile body 11 will be explained with reference to FIGS. 15 to 23.

An example of a case where the autonomous mobile body 11 independently executes a variety of motions and outputs a variety of output sounds without control of the information processing server 12 will be explained below.

### Motion Mode Deciding Process

First, a motion mode deciding process that is executed by the autonomous mobile body 11 will be explained with reference to a flowchart in FIG. 15.

This process is started when the autonomous mobile body 11 is turned on, and is ended when the autonomous mobile body 11 is turned off, for example.

At step S1, the recognition section 251 determines whether or not there is a change in pairing with a paired device. The recognition section 251 detects addition and cancellation of a paired device being paired with the autonomous mobile body 11, on the basis of sensor data, etc., supplied from the sensor section 202. In a case where addition or cancellation of a paired device is not detected, the recognition section 251 determines that there is no change in pairing with a paired device. The recognition section 251 repetitively makes this determination at a predetermined timing until determining that there is a change in pairing with a paired device.

On the other hand, in a case where addition or cancellation of a paired device is detected, the recognition section 251 determines that there is a change in pairing with a paired device. Then, the process proceeds to step S2.

It is to be noted that a method of recognizing a paired device is not limited to any particular method. Hereinafter, some examples of recognizing a paired device will be explained.

First, an example of a method of directly recognizing a paired device will be explained.

In one possible method, for example, a paired device may be electrically recognized. For example, an electric signal is caused to flow between the autonomous mobile body 11 and the paired device.

In one possible method, for example, a paired device may be recognized with a physical switch. For example, in a case where a paired device is attached to the autonomous mobile body 11, a contact switch provided on the autonomous mobile body 11 is pressed by the paired device, whereby the paired device is recognized. For example, in a case where a paired device is attached to the autonomous mobile body 11, an optical switch provided on the autonomous mobile body 11 is shaded by the paired device, whereby the paired device is recognized.

In one possible method, visual information such as a color or a bar code is used to optically recognize a paired device. For example, a paired device and features (e.g., color, shape) of the paired device are recognized on the basis of images captured by the camera 102L and the camera 102R.

In one possible method, for example, a paired device is recognized on the basis of a magnetic force. For example, a paired device is recognized on the basis of the magnetic force of a magnet provided on the paired device.

In one possible method, for example, a paired device is recognized on the basis of radio waves. For example, the recognition section 251 recognizes a paired device on the basis of a result of information that the communication device 122 of the autonomous mobile body 11 has read from an RFID (Radio Frequency Identifier) provided on the paired device, or a result of near field communication with the paired device through Bluetooth, Wi-Fi, or the like.

Next, an example of a method of indirectly recognizing a paired device on the basis of a motion change of the autonomous mobile body 11 caused by being paired with a device will be explained.

For example, a predetermined rule is applied to a detection value based on sensor data supplied from the sensor section 202, whereby a paired device is recognized.

For example, the ratio between a vibration amount of the autonomous mobile body 11 and a movement amount (odometry) of the autonomous mobile body 11 varies depending on whether the autonomous mobile body 11 is mounted on wheels or is mounted on a rotating wheel. For example, in a case where the autonomous mobile body 11 is mounted on wheels, the vibration amount of the autonomous mobile body 11 is reduced while the movement amount of the autonomous mobile body 11 is increased. On the other hand, in a case where the autonomous mobile body 11 is mounted on a rotating wheel, the vibration amount of the autonomous mobile body 11 is increased while the movement amount of the autonomous mobile body 11 is reduced. Accordingly, attachment of wheels or a rotating wheel to the autonomous mobile body 11 is recognized on the basis of the ratio between the vibration amount and the movement amount of the autonomous mobile body 11, for example.

For example, in a case where caterpillars or wheels larger than the wheel 107L and the wheel 107R are attached to the autonomous mobile body 11, the rolling resistance is increased. Therefore, attachment of the wheels or caterpillars to the autonomous mobile body 11 is recognized on the basis of a detected value of the rolling resistance of the autonomous mobile body 11.

For example, in a case where the autonomous mobile body 11 is attached to or joined with a paired device, motions of the autonomous mobile body 11 may be restricted. For example, the recognition section 251 recognizes a paired device by detecting the motion restriction on the autonomous mobile body 11, on the basis of the sensor data supplied from the sensor section 202.

It is to be noted that two or more of the abovementioned methods may be combined to recognize a paired device.

For example, a situation in which the autonomous mobile body 11 is mounted on wheels can be recognized on the basis of a vibration pattern of the autonomous mobile body 11 detected by the inertial sensor 121. In addition, a situation in which the autonomous mobile body 11 is mounted on wheels can be recognized on the basis of magnetic forces of magnets on the wheels detected by the magnetic sensor.

Here, in the recognition method using the inertial sensor 121, while a long time is required to recognize wheels, wheels that are not properly attached can be recognized. In contrast, in the recognition method using the magnetic sensor, while only a short period of time is required to recognize wheels, wheels that are not properly attached are difficult to recognize. Accordingly, if these two recognition methods are combined, the disadvantages thereof can be compensated, and the accuracy and speed of recognizing wheels are improved.

Also, for example, a discriminator generated by machine learning using sensor data supplied from the sensor section 202 can be used to recognize a paired device.

At step S2, the autonomous mobile body 11 changes the motion mode.

Specifically, the recognition section 251 supplies data indicating the presence/absence of a paired device being paired with the autonomous mobile body 11 and the type of the paired device, to the action planning section 252.

In a case where no device is paired with the autonomous mobile body 11, the action planning section 252 decides the motion mode to a normal mode.

On the other hand, in a case where a paired device is paired with the autonomous mobile body 11, the action planning section 252 decides a motion mode on the basis of the type of the paired device, for example.

For example, in a case where cat's ear-shaped optional parts (hereinafter, referred to as ear-shaped parts) are put on the head of the autonomous mobile body 11, the action planning section 252 decides the motion mode to a cat mode. For example, in a case where the autonomous mobile body 11 is in an automobile, the action planning section 252 decides the motion mode to an automobile mode.

It is to be noted that, in a case where two or more paired devices are paired with the autonomous mobile body 11, the action planning section 252 decides a motion mode on the basis of the pairing, for example. Alternatively, the action planning section 252 decides a motion mode on the basis of the priority levels of the paired devices and on the basis of the type of a paired device having the highest priority.

Alternatively, the action planning section 252 may decide a motion mode not on the basis of the type of the paired device but on the basis of only whether or not the autonomous mobile body 11 is paired with any device, for example.

The action planning section 252 supplies data indicating the decided motion mode to the motion control section 253 and the sound control section 254.

Then, the process returns to step S1, and the following steps are performed.

### Basic Example of Motion Sound Output Control Process

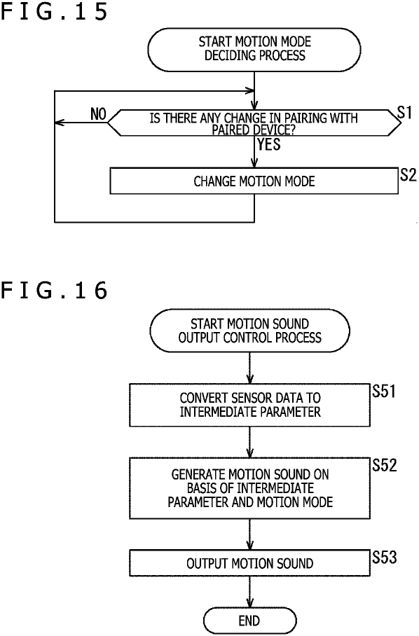

Next, a basic example of a motion sound output control process that is executed by the autonomous mobile body 11 will be explained with reference to a flowchart in FIG. 16.

At step S51, the recognition section 251 converts sensor data to an intermediate parameter.

For example, sensor data obtained by an acceleration sensor included in the inertial sensor 121 includes a component of a gravity acceleration. Accordingly, in a case where the sensor data obtained by the acceleration sensor is directly used to output a motion sound, the motion sound is constantly outputted even when the autonomous mobile body 11 is not in motion.

In addition, not only a component corresponding to movement of the autonomous mobile body 11 but also a component corresponding to vibration or noise is also included in sensor data obtained by the acceleration sensor because the sensor data includes accelerations in three axes which are an x axis, a y axis, and a z axis. Therefore, in a case where the sensor data obtained by the acceleration sensor is directly used to output a motion sound, the motion sound is outputted in response to not only movement of the autonomous mobile body 11 but also vibration or noise.

In contrast, the recognition section 251 converts sensor data obtained by the sensors included in the sensor section 202 to intermediate parameters that correspond to the condition of the autonomous mobile body 11, which is an output target of the motion sound, and that are intelligible to human beings.

Specifically, the recognition section 251 acquires sensor data from the sensors included in the sensor section 202, and performs, on the sensor data, an arithmetic and logical operation such as filtering or threshold processing, whereby the sensor data is converted to predetermined types of intermediate parameters.

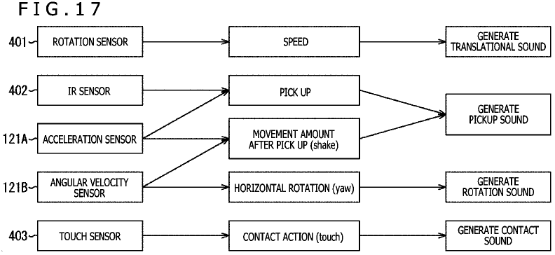

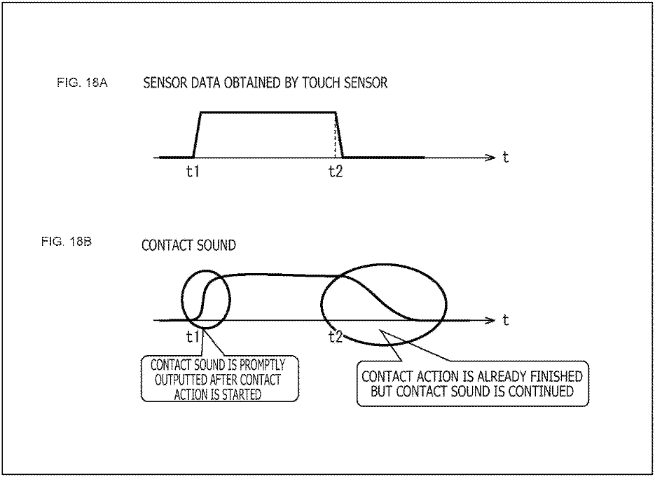

FIG. 17 depicts a specific example of a method of converting sensor data to an intermediate parameter.

For example, the recognition section 251 acquires, from a rotation sensor 401 included in the sensor section 202, sensor data indicating the rotational speed of the motor 125D or motor 125E of the autonomous mobile body 11. The recognition section 251 calculates the movement amount of the autonomous mobile body 11 by calculating an odometry on the basis of the rotational speed of the motor 125D or motor 125E. In addition, the recognition section 251 calculates the speed (hereinafter, referred to as a translational speed), in the translational direction (front, rear, left, and right directions), of the autonomous mobile body 11 on the basis of the movement amount of the autonomous mobile body 11. Accordingly, the sensor data is converted to a speed (translational speed) which is an intermediate parameter.

For example, the recognition section 251 acquires, from an IR sensor 402 (not depicted in FIGS. 2 to 9) included in the sensor section 202 and disposed on the bottom surface of the autonomous mobile body 11, sensor data indicating whether or not any object (e.g., floor surface) is approaching the bottom surface. In addition, the recognition section 251 acquires, from an acceleration sensor 121A included in the inertial sensor 121, sensor data indicating the acceleration of the autonomous mobile body 11. The recognition section 251 recognizes whether or not the autonomous mobile body 11 is being picked up, on the basis of whether or not an object is approaching the bottom surface of the autonomous mobile body 11 and the acceleration of the autonomous mobile body 11. Accordingly, the sensor data is converted to an intermediate parameter which indicates whether or not the autonomous mobile body 11 is being picked up.

For example, the recognition section 251 acquires, from the acceleration sensor 121A, sensor data indicating the acceleration of the autonomous mobile body 11. In addition, the recognition section 251 acquires, from an angular velocity sensor 121B included in the inertial sensor 121, sensor data indicating the angular velocity of the autonomous mobile body 11. The recognition section 251 detects an amount of movement made after the autonomous mobile body 11 is picked up, on the basis of the acceleration and the angular velocity of the autonomous mobile body 11. The movement amount indicates an amount by which the picked-up autonomous mobile body 11 is shaken, for example. Accordingly, the sensor data is converted to, as an intermediate parameter, a movement amount of the picked-up autonomous mobile body 11.

For example, the recognition section 251 acquires, from the angular velocity sensor 121B, sensor data indicating the angular velocity of the autonomous mobile body 11. The recognition section 251 detects rotation (horizontal rotation) in a yaw direction about the up-down axis of the autonomous mobile body, on the basis of the angular velocity of the autonomous mobile body 11. Accordingly, the sensor data is converted to, as an intermediate parameter, horizontal rotation of the autonomous mobile body 11.

For example, the recognition section 251 acquires, from a touch sensor 403 included in the sensor section 202 and provided in at least one portion that a user is highly likely to touch, sensor data indicating whether the autonomous mobile body 11 is touched or not. The touch sensor 403 includes an electrostatic capacity type sensor or a pressure sensitive touch sensor, for example. The recognition section 251 recognizes a user's contact action such as touching, patting, tapping, or pushing, on the basis of the presence/absence of a touch on the autonomous mobile body 11. Accordingly, the sensor data is converted to, as an intermediate parameter, the presence/absence of a contact action on the autonomous mobile body 11.

At step S52, the sound control section 254 generates a motion sound on the basis of the intermediate parameters and the motion mode.

For example, in a case where the speed of the autonomous mobile body 11 is equal to or greater than a predetermined threshold, the sound control section 254 generates a translational sound which is a motion sound corresponding to a translational motion of the autonomous mobile body 11. In this case, the sound control section 254 changes some of the parameters including the pitch (e.g., frequency), the volume, the tone color (e.g., a frequency component, a modulation level), and the speed of the translational sound on the basis of the speed of the autonomous mobile body 11 and the motion mode, etc., for example.

For example, in a case where the motion mode is set to the normal mode, a continuous sound corresponding to the speed of the autonomous mobile body 11 and imitating a rotation sound of wheels is generated as a translational sound.

For example, in a case where the motion mode is set to the abovementioned cat mode, a sound imitating a footstep of a cat is generated as a translational sound.

For example, in a case where the motion mode is set to the abovementioned vehicle mode, a sound whose pitch changes according to the speed of the autonomous mobile body 11 and which imitates a traveling sound of a vehicle is generated as a translational sound.

For example, in a case where the autonomous mobile body 11 is picked up, the sound control section 254 generates a pick-up sound which is a motion sound corresponding to picking up of the autonomous mobile body 11. In this case, the sound control section 254 changes some of the parameters concerning the pitch, the volume, the tone color, and the speed of the pick-up sound on the basis of the motion mode and a change in the movement amount of the picked-up autonomous mobile body 11, for example.

For example, in a case where the motion mode is set to the normal mode, a sound as if a person is surprised is generated as a pick-up sound.

For example, in a case where the motion mode is set to the cat mode, a sound including a low component as if a cat is angry is generated as a pick-up sound.

It is to be noted that, for example, in a case where the motion mode is set to the vehicle mode, no pick-up sound is generated and outputted.

For example, in a case where the horizontal rotational speed of the autonomous mobile body 11 is equal to or greater than a predetermined threshold, the sound control section 254 generates a rotation sound which is a motion sound corresponding to horizontal rotation of the autonomous mobile body 11. Here, the sound control section 254 changes some of parameters of the pitch, the volume, the tone color, and the speed of the rotation sound on the basis of a change in the horizontal rotational speed of the autonomous mobile body 11 and the motion mode, for example.

For example, in a case where the motion mode is set to the normal mode, a rotation sound whose pitch varies according to the rotational speed of the autonomous mobile body 11 is generated.

For example, in a case where the motion mode is set to the cat mode, a rotation sound whose pitch varies according to the rotational speed of the autonomous mobile body 11 and whose tone color differs from that in the normal mode is generated.

For example, in a case where the motion mode is set to the vehicle mode, a rotation sound whose pitch varies according to the rotational speed of the autonomous mobile body 11 and whose tone color differs from that in the normal mode or that in the cat mode is generated. For example, a translational sound imitating a rotation sound of a motor is generated.

For example, in a case where a contact action on the autonomous mobile body 11 is recognized, the sound control section 254 generates a contact sound which is a motion sound indicating a reaction of the autonomous mobile body 11 to the contact action. Here, the sound control section 254 changes some of the parameters concerning the pitch, the volume, the tone color, and the speed of the contact sound on the basis of the motion mode and the type, the duration length, and the strength of the contact action on the autonomous mobile body 11, for example.

For example, in a case where the motion mode is set to the cat mode, a sound imitating a cat voice is generated as a contact sound.

It is to be noted that, in a case where the motion mode is set to the normal mode or vehicle mode, for example, no contact sound is generated and outputted.

In the abovementioned manner, the motion sound is decided to correspond to the type of a paired device.

At step S53, the autonomous mobile body 11 outputs the motion sound. Specifically, the sound control section 254 generates output sound data for outputting the generated motion sound, and supplies the output sound data to the sound output section 205. The sound output section 205 outputs the motion sound on the basis of the obtained output sound data.

It is to be noted that, for example, the sound control section 254 sets the reaction speed of a motion sound to be outputted when recognition of a trigger condition of the autonomous mobile body 11 (e.g., a motion of the autonomous mobile body 11 or a stimulus to the autonomous mobile body 11) for outputting an output sound is started, to be higher than the reaction speed of a motion sound to be outputted when recognition of the condition is ended. For example, the sound control section 254 controls outputting a motion sound in such a way that a motion sound is promptly activated when recognition of the condition is started and a motion sound is gradually stopped when recognition of the condition is ended.

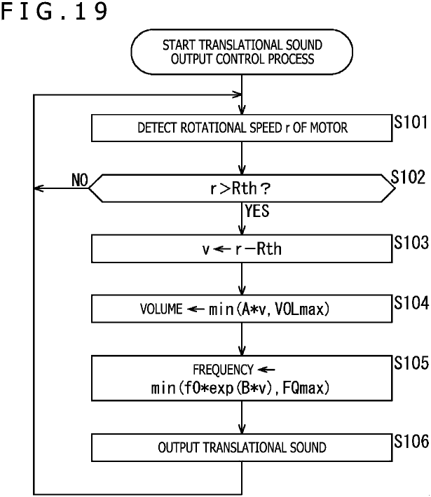

For example, A in FIG. 18 illustrates a graph indicating the waveform of sensor data obtained by the touch sensor 403. The horizontal axis and the vertical axis indicate a time and a sensor data value, respectively. B in FIG. 18 illustrates a graph indicating the waveform of a contact sound. The horizontal axis and the vertical axis indicate a time and the volume of a contact sound, respectively.

For example, when a user starts a contact action on the autonomous mobile body 11 at time t1, the touch sensor 403 starts outputting sensor data. Accordingly, the recognition section 251 starts recognition of the contact action. Here, the sound control section 254 quickly activates the contact sound. That is, the sound control section 254 starts outputting a contact sound substantially simultaneously with the start of recognition of the contact action, and quickly increases the volume of the contact sound.

On the other hand, when the user finishes the contact action on the autonomous mobile body 11 at time t2, the touch sensor 403 stops outputting the sensor data. Accordingly, the recognition of the contact action by the recognition section 251 is ended. Here, the sound control section 254 gradually stops the contact sound. That is, after finishing recognition of the contact action, the sound control section 254 slowly lowers the volume of the contact sound and continues outputting the contact sound for a while.

Accordingly, a more natural contact sound is outputted. For example, since a contact sound is outputted substantially simultaneously with start of a user's contact action, start of unnatural output of a contact sound is prevented after the contact action is ended even when the user's contact action lasts for only a short period of time. In addition, the reverberation of the contact sound is left after the user contact action is ended, whereby unnatural sudden stop of the contact sound is prevented.

For example, like the contact sound, the translational sound may be also controlled. For example, substantially simultaneously with the start of recognition of movement of the autonomous mobile body 11 in the translational direction, the translational sound may be promptly activated, and, when the recognition of the movement of the autonomous mobile body 11 in the translational direction is ended, the translational sound may be gradually stopped.

### Specific Example of Translational Sound Output Control Process

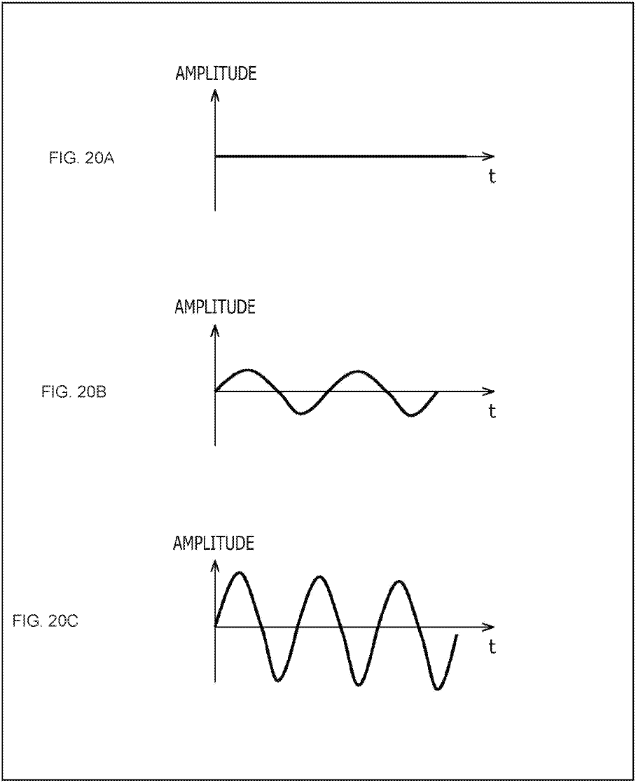

Next, a specific example of a translational sound output control process will be explained with reference to FIGS. 19 to 22. Specifically, a specific example of the translational sound output control process to be executed in a case where no ear-shaped part, which is one example of the optional parts, is put on the autonomous mobile body 11 and a specific example of the translational sound output control process to be executed in a case where the ear-shaped parts are put on the autonomous mobile body 11 will be explained.

### Translational Sound Output Control Process During Normal Mode

First, a translational sound output control process, which is executed in a case where no ear-shaped part is put on the autonomous mobile body 11 and the motion mode is set to the normal mode, will be explained with reference to a flowchart in FIG. 19.

This process is started when the autonomous mobile body 11 is turned on, and is ended when the autonomous mobile body 11 is turned off, for example.

At step S101, the recognition section 251 detects the rotational speed r of a motor. Specifically, the recognition section 251 acquires, from the rotation sensor 401 included in the sensor section 202, sensor data indicating the rotational speed of the motor 125D or motor 125E of the autonomous mobile body 11. The recognition section 251 detects the rotational speed r of the motor 125D or motor 125E on the basis of the acquired sensor data.

At step S102, the recognition section 251 determines whether or not the rotational speed r > threshold Rth holds. In a case where it is determined that the rotational speed r ≤ threshold Rth, the translational sound is not outputted. Then, the process returns to step S101. In a case where the translational speed of the autonomous mobile body 11 is equal to or less than a predetermined threshold, the translational sound is not outputted because the rotational speed r is substantially proportional to the translational speed of the autonomous mobile body 11.

Thereafter, processes of steps S101 and S102 are repeatedly executed until the rotational speed r > threshold Rth is determined to hold at step S102.

On the other hand, in a case where the rotational speed r > threshold Rth is determined to hold at step S102, that is, in a case where the translational speed of the autonomous mobile body 11 is greater than a predetermined threshold, the process proceeds to step S103.

At step S103, the recognition section 251 sets the rotational speed r - threshold Rth to a variable v. The variable v is proportional to the rotational speed r, and is substantially proportional to the translational speed of the autonomous mobile body 11. The recognition section 251 supplies data indicating the variable v to the sound control section 254.

At step S104, the sound control section 254 sets the volume of the translational sound to min (A*v, VOLmax). Here, A represents a predetermined coefficient. In addition, the volume VOLmax represents the maximum volume of the translational sound. Accordingly, within a range of the maximum volume VOLmax or lower, the volume of translational sound is set to be substantially proportional to the translational speed of the autonomous mobile body 11.

At step S105, the sound control section 254 sets the frequency of the translational sound to min (f0*exp(B*v), FQmax). Here, B represents a predetermined coefficient. The frequency FQmax represents the maximum frequency of the translational sound.

The frequency of a sound that is comfortable for people ranges from approximately 200 to 2000 Hz. In addition, the sound resolution of human beings becomes higher when the frequency is lower but becomes lower when the frequency is higher. Therefore, within the range of the maximum frequency FQmax (e.g., 2000 Hz) or lower, the frequency (pitch) of the translational sound is adjusted to exponentially vary with respect to the translational speed of the autonomous mobile body 11.

At step S106, the autonomous mobile body 11 outputs the translational sound. Specifically, the sound control section 254 generates output sound data for outputting a translational speed by the set volume and frequency, and supplies the output sound data to the sound output section 205. The sound output section 205 outputs a translational sound on the basis of the obtained output sound data.

Thereafter, the process returns to step S101, and the following steps are executed.

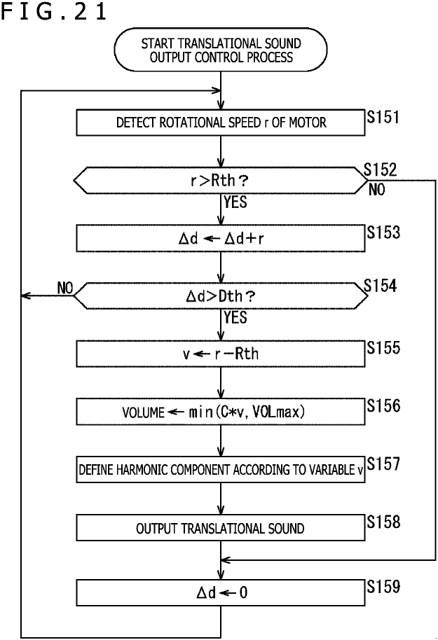

Accordingly, in a case where the translational speed of the autonomous mobile body 11 is equal to or less than a predetermined threshold, for example, the translational sound is not outputted, as depicted in A of FIG. 20. On the other hand, in a case where the translational speed of the autonomous mobile body 11 is greater than a predetermined threshold, the frequency (pitch) of the translational sound becomes higher and the amplitude (volume) of the translational sound becomes larger with an increase of the translational speed, as depicted in B and C of FIG. 20.

### Translational Sound Output Control Process During Cat Mode

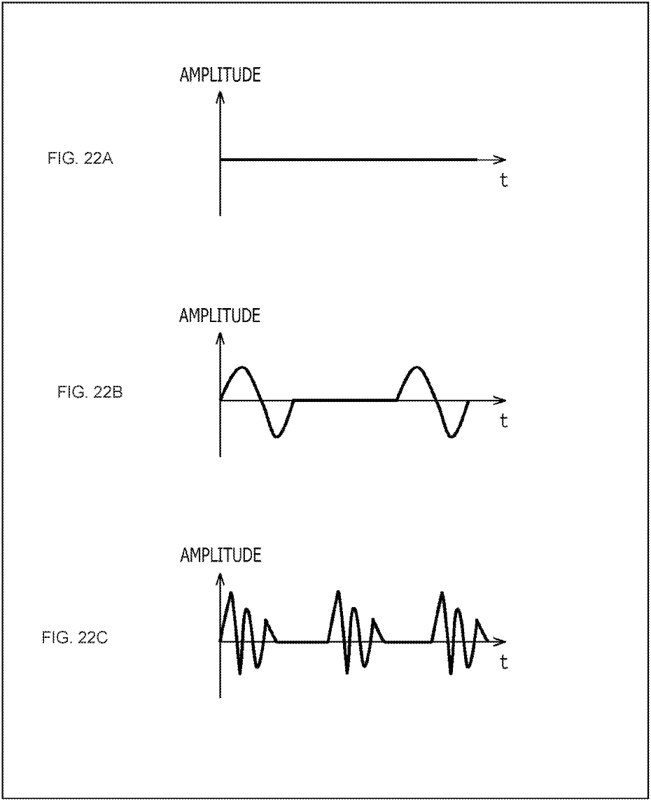

Next, the translational sound output control process, which is executed in a case where the ear-shaped parts are put on the autonomous mobile body 11 and the motion mode is set to the cat mode, will be explained with reference to a flowchart in FIG. 21.

This process is started when the autonomous mobile body 11 is turned on, and is ended when the autonomous mobile body 11 is turned off, for example.

At step S151 which is similar to step S101 in FIG. 19, the rotational speed r of the motor is detected.

At step S152 which is similar to step S102 in FIG. 19, whether or not the rotational speed r > threshold Rth holds is determined. In a case where the rotational speed r > threshold Rth is determined to hold, the process proceeds to step S153.

At step S153, the recognition section 251 adds the rotational speed r to a movement amount Δd. The movement amount Δd is an integrated value of the rotational speed of the motor since the start of movement of the autonomous mobile body 11 in the translational direction, or the rotational speed of the motor since the output of the last translational sound. The movement amount Δd is substantially proportional to the movement amount, in the translational direction, of the autonomous mobile body 11.

At step S154, the recognition section 251 determines whether or not the movement amount Δd > threshold Dth. In a case where movement amount Δd ≤ threshold Dth is determined, the translational sound is not outputted. Then, the process returns to step S151. That is, in a case where the movement amount in the translational direction after movement of the autonomous mobile body 11 in the translational direction is started or the movement amount in the translational direction after the last output of the translational sound is equal to or less than a predetermined threshold, the translational sound is not outputted.

Thereafter, processes of steps S151 to S154 are repeatedly executed until the rotational speed r ≤ threshold Rth is determined to hold at step S152, or the movement amount Δd > threshold Dth is determined at step S154.

On the other hand, in a case the movement amount Δd > threshold Dth is determined at step S154, that is, in a case where the movement amount in the translational direction since movement of the autonomous mobile body 11 in the translational direction is started or the movement amount in the translational direction since the last translational sound is outputted is greater than a predetermined threshold, the process proceeds to step S155.

At step S155, the rotational speed r - the threshold Rth is set as the variable v, as in step S103 in FIG. 19.

At step S156, the sound control section 254 sets the volume of the translational sound to min (C*v, VOLmax). Here, C represents a predetermined coefficient. As a result, the volume of the translational sound is set to be substantially proportional to the translational speed of the autonomous mobile body 11 within a range of the maximum volume VOLmax or lower.

It is to be noted that the coefficient C is set to be smaller than the coefficient A which is used in step S104 in FIG. 19, for example. Therefore, the variation of the volume of the translational sound relative to the translational speed of the autonomous mobile body 11 in the cat mode is smaller than that in the normal mode.

At step S157, the sound control section 254 sets a harmonic component according to the variable v. Specifically, the sound control section 254 sets a harmonic component of the translational sound in such a way that the harmonic component is increased with an increase of the variable v, that is, with an increase of the translational speed of the autonomous mobile body 11.

At step S158, the autonomous mobile body 11 outputs a translational sound. Specifically, the sound control section 254 generates output sound data for outputting a translational sound including the set harmonic component by the decided volume and supplies the output sound data to the sound output section 205. The sound output section 205 outputs a translational sound on the basis of the obtained output sound data.

Thereafter, the process proceeds to step S159.

On the other hand, in a case where the rotational speed r ≤ threshold Rth is determined to hold at step S152, that is, in a case where the translational speed of the autonomous mobile body 11 is equal to or less than a predetermined threshold, steps S153 to S158 are skipped, and the process proceeds to step S159.

At step S159, the recognition section 251 sets the movement amount Δd to 0. That is, after the translational sound is outputted or the translational speed of the autonomous mobile body 11 becomes equal to or less than a predetermined threshold, the movement amount Δd is reset to 0.

Thereafter, the process returns to step S151, and the following steps are executed.

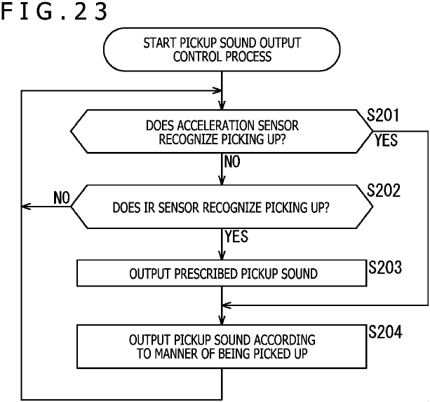

As a result, as depicted in A of FIG. 22, the translational sound is not outputted in a case where the translational speed of the autonomous mobile body 11 is equal to or less than a predetermined threshold, for example. In contrast, as depicted in B and C of FIG. 22, in a case where the translational speed of the autonomous mobile body 11 is greater than the predetermined threshold, the translational sound is intermittently outputted with some silent periods. In addition, with an increase of the speed, the harmonic component of the translational sound becomes higher, and an interval between the output timings of the translational sound becomes smaller.

In such a manner, a translational sound control method is changed according to whether or not ear-shaped parts are put on the autonomous mobile body 11.

For example, in a case where ear-shaped parts are put on the autonomous mobile body 11, a motion sound is changed to a sound imitating a cat motion sound. For example, in a case where the autonomous mobile body 11 moves in a translational direction, a translational sound is intermittently outputted without being continuously outputted, as if the sound of cat's footsteps is heard. In addition, it is considered that real cats kick the ground more strongly with an increase of the movement speed and the sound of footsteps becomes solid. Therefore, when the translational speed of the autonomous mobile body 11 is higher, the harmonic component of the translational sound is increased to output a more solid sound.

In the abovementioned manner, a user can surely feel that the character of the autonomous mobile body 11 is changed according to whether or not ear-shaped parts are put on the autonomous mobile body 11, whereby the degree of satisfaction of the user is improved.

It is to be noted that the tone color of the translational sound may be set by applying the variable v, an integer time of the variable v, or a value obtained by applying an exponential function to the variable v, to a predetermined filter, for example.

In addition, a sound having a predetermined waveform may be previously created or recorded, and a translational sound may be generated by dynamically changing the pitch and volume of the sound on the basis of the variable v, for example. In addition, for example, translational sounds having multiple waveforms may be previously created or recorded, and a sound for use may be switched on the basis of the variable v. For example, a sound of softly kicking the ground and a sound of strongly kicking the ground may be previously created, and a translational sound may be generated by varying the combination ratio of these sounds on the basis of the variable v.

Further, the rotation sound may be controlled in a manner similar to that of the translational sound. For example, the rotation sound may be outputted in a case where the absolute value a of an angular velocity detected by the angular velocity sensor 121B is greater than a predetermined threshold Ath, and the variable v may be set to the absolute value a of angular velocity - threshold Ath and may be used for controlling the rotation sound.

Also, a pickup sound may be controlled in a manner similar to those of the translational sound and the rotation sound. In this case, a pickup sound is modulated so as to express the rapidness of picking up the autonomous mobile body 11, on the basis of the difference in the acceleration detected by the acceleration sensor 121A between frames, for example.

### Specific Example of Pickup Sound Output Control Process

In a case where conditions of the autonomous mobile body 11 are each recognized by multiple types of sensors, the recognition characteristics including the recognition speed and the recognition accuracy may vary according to the characteristics of each sensor.

For example, whether the autonomous mobile body 11 is picked up is recognized with use of the IR sensor 402 and the acceleration sensor 121A, as previously explained with reference to FIG. 17. Furthermore, a difference in a characteristic of recognizing picking up of the autonomous mobile body 11 is generated between a case where the IR sensor 402 is used and a case where the acceleration sensor 121A is used, as explained later.

In contrast, when output sound control is performed by a control method suited for the characteristics of each sensor, the response performance of an output sound and variation of expressions can be improved.

Here, a specific example of a process of controlling output of a pickup sound will be explained with reference to FIG. 23.

This process is started when the autonomous mobile body 11 is turned on, and is ended when the autonomous mobile body 11 is turned off.

At step S201, the recognition section 251 determines whether or not the acceleration sensor 121A has recognized picking up. In a case where it is not recognized that the autonomous mobile body 11 is picked up, on the basis of sensor data supplied from the acceleration sensor 121A, the recognition section 251 determines that the acceleration sensor 121A has not recognized picking up. Then, the process proceeds to step S202.

At step S202, the recognition section 251 determines whether or not the IR sensor 402 has recognized picking up. In a case where it is not recognized that the autonomous mobile body 11 is picked up, on the basis of sensor data supplied from the IR sensor 402, the recognition section 251 determines that the IR sensor 402 has not recognized picking up. Then, the process returns to step S201.

Thereafter, step S201 and step S202 are repeatedly executed until it is determined, at step S201, that the acceleration sensor 121A has recognized picking up or until it is determined, at step S202, that the IR sensor 402 has recognized picking up.

On the other hand, in a case where it is recognized, at step S202, that the autonomous mobile body 11 is picked up, on the basis of sensor data supplied from the IR sensor 402, the recognition section 251 determines that the IR sensor 402 has recognized picking up. Then, the process proceeds to step S203.

For example, in a case where the IR sensor 402 is used, the recognition accuracy is high, irrespective of the way of picking up the autonomous mobile body 11. On the other hand, in a case where the acceleration sensor 121A is used, the recognition accuracy is high when the autonomous mobile body 11 is quickly picked up, but the recognition accuracy is low when the autonomous mobile body 11 is slowly picked up. In addition, in a case where the acceleration sensor 121A is used, it is difficult to differentiate between picking up of the autonomous mobile body 11 and another motion of the autonomous mobile body 11.

Moreover, the sampling rate of the IR sensor 402 is generally lower than that of the acceleration sensor 121A. Therefore, in a case where the IR sensor 402 is used, the speed (reaction speed) of recognizing that the autonomous mobile body 11 is picked up may become low, compared to a case where the acceleration sensor 121A is used.

Therefore, the process proceeds to step S203 in a case where, prior to the acceleration sensor 121A, the IR sensor 402 recognizes that the autonomous mobile body 11 is picked up. For example, it is assumed that the process proceeds to step S203 in a case where the autonomous mobile body 11 is slowly picked up.

At step S203, the autonomous mobile body 11 outputs a predetermined pickup sound. Specifically, the recognition section 251 reports that the autonomous mobile body 11 is picked up, to the sound control section 254. The sound control section 254 generates output sound data for outputting a pickup sound by a predetermined pitch, volume, tone color, and speed, and supplies the output sound data to the sound output section 205. The sound output section 205 outputs a pickup sound on the basis of the acquired output sound data.

Here, a movement amount after the autonomous mobile body 11 is picked up is detected with use of the acceleration sensor 121A and the angular velocity sensor 121B, as previously explained with reference to FIG. 17. In contrast, the IR sensor 402 cannot detect a movement amount after the autonomous mobile body 11 is picked up. Therefore, in a case where, prior to the acceleration sensor 121A, the IR sensor 402 recognizes that the autonomous mobile body 11 is picked up, it is difficult to detect a movement amount after the autonomous mobile body 11 is picked up.

Therefore, in a case where, prior to the acceleration sensor 121A, the IR sensor 402 has recognized that the autonomous mobile body 11 is picked up, a fixed pickup sound is outputted, irrespective of the way of picking up the autonomous mobile body 11.

Thereafter, the process proceeds to step S204.

On the other hand, in a case where it is recognized that, at step S201, that the autonomous mobile body 11 is picked up, on the basis of sensor data supplied from the acceleration sensor 121A, the recognition section 251 determines that the acceleration sensor 121A has recognized picking up. Then, step S202 and step S203 are skipped, and the process proceeds to step S204.

This happens in a case where, prior to or substantially simultaneously with the IR sensor 402, the acceleration sensor 121A recognizes that the autonomous mobile body 11 is picked up, or the autonomous mobile body 11 is speedily picked up, for example.

At step S204, the autonomous mobile body 11 outputs a pickup sound according to the way of being picked up.

Specifically, the recognition section 251 detects an amount of motion made after the autonomous mobile body 11 is picked up, on the basis of sensor data supplied from the acceleration sensor 121A and the angular velocity sensor 121B. The recognition section 251 supplies data indicating the detected motion amount to the sound control section 254.

The sound control section 254 generates a pickup sound. Here, the sound control section 254 changes some of the parameters concerning the pitch, the volume, the tone color, and the speed of the pickup sound on the basis of the motion mode and a change in the amount of movement made after the autonomous mobile body 11 is picked up, for example.

It is to be noted that, in a case where a pickup sound has been already outputted at step S203, a parameter concerning a pickup sound is defined to provide natural continuity with a fixed pickup sound.

The sound control section 254 generates output sound data for outputting the generated pickup sound and supplies the output sound data to the sound output section 205.

The sound output section 205 outputs a pickup sound on the basis of the acquired output sound data.

Thereafter, the process returns to step S201, and the following steps are executed.

In the manner described so far, a pickup sound is quickly outputted, irrespective of the way of picking up the autonomous mobile body 11. In addition, a pickup sound according to the way of picking up the autonomous mobile body 11 is outputted.

In the manner explained so far, a proper motion sound is outputted at a proper timing according to a condition of the autonomous mobile body 11, or particularly, according to pairing with a paired device. In addition, the responsivity of a motion sound and variation of expressions of the autonomous mobile body 11 are improved. As a result of this, a user experience based on a motion sound of the autonomous mobile body 11 is improved.

### 2. Modifications

Hereinafter, modifications of the abovementioned embodiment according to the present technology will be explained.

The abovementioned types of a motion sound, the abovementioned types of a paired device, and the motion sound control methods are just examples and can be changed in any way. For example, the autonomous mobile body 11 may be configured to, in a case of being mounted on a robotic vacuum cleaner, output a motion sound as if cleaning a room.

The examples of controlling, as an output sound, a motion sound on the basis of pairing with a paired device have been explained so far. However, a speech sound may also be controlled in a similar manner.

For example, the output sound control method in a case where the autonomous mobile body 11 is paired with a paired device may be decided by a user.

For example, the autonomous mobile body 11 may decide the output sound control method on the basis of a paired device and any other condition. For example, in a case where the autonomous mobile body 11 is paired with a paired device, the output sound control method may be decided further on the basis of such conditions as a time (e.g., time of day or season) or a location.

In a case where another autonomous mobile body (e.g., robot) is formed by joining the autonomous mobile body 11 and another paired device, output sound control may be performed not on the autonomous mobile body 11 alone but on the whole of the newly formed autonomous mobile body, for example.

For example, not only in a case where the autonomous mobile body 11 is in contact with a paired device, but also in a case where the autonomous mobile body 11 is not in contact with a paired device, it may be recognized that the autonomous mobile body 11 is paired with the device, and the output sound control method may be changed. For example, in a case where the autonomous mobile body 11 and another paired device such as a robot are close to each other, it may be recognized that the autonomous mobile body 11 is paired with the paired device, and the output sound control method may be changed.

In this case, approaching movement of another device to be paired is recognized on the basis of images captured by the camera 102L and the camera 102R, for example. However, in a case where the images are used, the autonomous mobile body 11 cannot recognize approaching movement of the device to be paired if the device is in a dead angle of the autonomous mobile body 11. In contrast, approaching movement of a device to be paired may be recognized by near field communication, as previously explained.

For example, in a case where a device to be paired is put on a user and the autonomous mobile body 11 and the user with the device to be paired come close to each other, the output sound control method may be changed. Accordingly, for example, in a case where the user comes back home, the autonomous mobile body 11 can wait for the user at the door and output an output sound as if expressing a joy.

For example, by using images captured by the camera 102L and the camera 102R or a human detection sensor, the autonomous mobile body 11 may recognize a user, irrespective of the presence/absence of a paired device, and define the output sound control method on the basis of pairing with the user.

For example, the output sound control method may be changed according to a change in the shape of the autonomous mobile body 11. For example, the output sound control method may be changed in such a manner as to output an output sound corresponding to a living being or character close to the changed shape of the autonomous mobile body 11.

For example, in a case where an electronic device such as a smartphone different from the autonomous mobile body is paired with a paired device, a control method for an output sound of the electronic device may be changed. For example, in a case where the smartphone is mounted on and moved by a rotating wheel, the smartphone may output a motion sound corresponding to rotation of wheels of the rotating wheel.

For example, in a case where the autonomous mobile body 11 is paired with a paired device, a sensor of the paired device may be used to recognize a condition of the autonomous mobile body 11.

For example, the information processing server 12 can receive sensor data from the autonomous mobile body 11 and control an output sound of the autonomous mobile body 11 on the basis of the received sensor data, as previously explained. In addition, in a case where the information processing server 12 controls an output sound of the autonomous mobile body 11, the information processing server 12 may generate the output sound, or the autonomous mobile body 11 may generate the output sound under control of the information processing server 12.

### 3. Others

### Configuration Example of Computer

The abovementioned series of processes can be executed by hardware or can be executed by software. In a case where the series of processes is executed by software, a program forming the software is installed into a computer. Here, examples of the computer include a computer incorporated in dedicated hardware and a general-purpose personal computer capable of executing various functions by installing thereinto various programs.

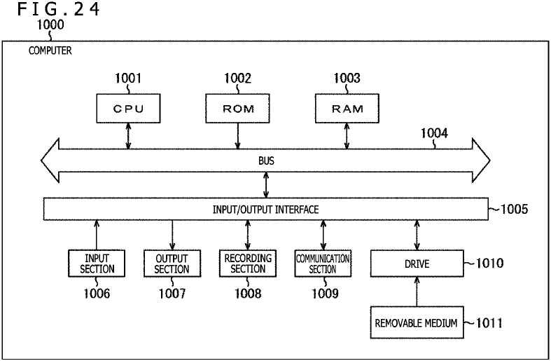

FIG. 24 is a block diagram depicting a configuration example of computer hardware for executing the abovementioned series of processes in accordance with a program.

In a computer 1000, a CPU (Central Processing Unit) 1001, a ROM (Read Only Memory) 1002, and a RAM (Random Access Memory) 1003 are mutually connected via a bus 1004.

Further, an input/output interface 1005 is connected to the bus 1004. An input section 1006, an output section 1007, a recording section 1008, a communication section 1009, and a drive 1010 are connected to the input/output interface 1005.

The input section 1006 includes an input switch, a button, a microphone, an imaging element, or the like. An output section 1007 includes a display, a loudspeaker, or the like. The recording section 1008 includes a hard disk, a nonvolatile memory, or the like. The communication section 1009 includes a network interface or the like. The drive 1010 drives a removable medium 1011 such as a magnetic disk, an optical disk, a magnetooptical disk, or a semiconductor memory.

In the computer 1000 having the abovementioned configuration, the CPU 1001 loads a program recorded in the recording section 1008 into the RAM 1003 via the input/output interface 1005 and the bus 1004, for example, whereby the abovementioned series of processes is executed.

A program to be executed by the computer 1000 (CPU 1001) can be provided by being recorded in the removable medium 1011 as a package medium, for example. Alternatively, the program can be provided via a wired or wireless transmission medium such as a local area network, the Internet, or digital satellite broadcasting.

In the computer 1000, when the removable medium 1011 is attached to the drive 1010, a program can be installed into the recording section 1008 via the input/output interface 1005. Further, the program can be received by the communication section 1009 via a wired or wireless transmission medium and can be installed into the recording section 1008. Alternatively, the program can be previously installed in the ROM 1002 or the recording section 1008.

It is to be noted that the program which is executed by the computer may be a program for executing the processes in the time-series order explained herein, or may be a program for executing the processes at a necessary timing such as a timing when a call is made.

Moreover, the term "system" in the present description means a set of multiple constituent components (devices, modules (components), etc.), and whether or not all the constituent components are included in the same casing does not matter. Therefore, a set of multiple devices that are housed in different casings and are connected over a network is a system, and further, a single device having multiple modules housed in a single casing is also a system.

In addition, the embodiments of the present technology are not limited to the abovementioned embodiments, and various changes can be made within the scope of the gist of the present technology.

For example, the present technology can be configured by cloud computing in which one function is shared and cooperatively processed by multiple devices over a network.

In addition, each step having been explained with reference to the abovementioned flowcharts may be executed by one device or may be cooperatively executed by multiple devices.

Furthermore, in a case where a plurality of processes is included in one step, the plurality of processes included in the one step may be executed by one device or may be cooperatively executed by multiple devices.

### Configuration Combination Examples

The present technology can also have the following configurations.

(1) An autonomous mobile body including:
   a recognition section that recognizes a paired device that is paired with the autonomous mobile body; and
   a sound control section that changes a control method for an output sound to be outputted from the autonomous mobile body, on the basis of a recognition result of the paired device, and controls the output sound in accordance with the changed control method.
(2) The autonomous mobile body according to (1), in which
   the recognition section further recognizes a condition of the autonomous mobile body, and
   the sound control section controls the output sound on the basis of the condition of the autonomous mobile body.
(3) The autonomous mobile body according to (2), in which
   the sound control section sets a reaction speed of the output sound when recognition of a predetermined condition is started, to be higher than a reaction speed of the output sound when the recognition of the predetermined condition is ended.
(4) The autonomous mobile body according to (3), in which
   the sound control section promptly activates the output sound when the recognition of the predetermined condition is started, and slowly stops the output sound when the recognition of the predetermined condition is ended.
(5) The autonomous mobile body according to (3) or (4), in which
   the predetermined condition includes a motion of the autonomous mobile body or a stimulus to the autonomous mobile body.
(6) The autonomous mobile body according to any one of (2) to (5), in which
   the recognition section recognizes conditions of the autonomous mobile body by respectively using multiple types of sensors, and
   the sound control section changes the control method for the output sound on the basis of the type of the sensor used for recognizing the condition of the autonomous mobile body.
(7) The autonomous mobile body according to (6), in which
   the sound control section controls the output sound by a control method corresponding to a characteristic of the sensor used for recognizing the condition of the autonomous mobile body.
(8) The autonomous mobile body according to any one of (1) to (7), in which
   the sound control section changes at least one of the output sound to be generated and an output timing of the output sound on the basis of the recognition result of the paired device.
(9) The autonomous mobile body according to (8), in which
   the sound control section changes the output sound according to a type of the paired device that is paired with the autonomous mobile body.
(10) The autonomous mobile body according to (8) or (9), in which
   the sound control section changes at least one of a pitch, a volume, a tone color, and a speed of the output sound.
(11) The autonomous mobile body according to any one of (1) to (10), in which
   the sound control section changes the control method for the output sound on the basis of a type of the recognized paired device.
(12) The autonomous mobile body according to any one of (1) to (11), in which
   the output sound includes a sound that is outputted in response to a motion of the autonomous mobile body or a sound that is outputted in response to a stimulus to the autonomous mobile body.
(13) The autonomous mobile body according to any one of (1) to (12), in which
   the recognition section recognizes the paired device on the basis of sensor data supplied from one or more types of sensors.
(14) The autonomous mobile body according to (13), in which
   the recognition section recognizes the paired device on the basis of a motion change in the autonomous mobile body, and the motion change is recognized on the basis of the sensor data.
(15) The autonomous mobile body according to any one of (1) to (14), in which
   the paired device includes at least one of a part that is attachable to and detachable from the autonomous mobile body, a device that is attachable to and detachable from the autonomous mobile body, and a mobile body on which the autonomous mobile body is capable of being mounted.
(16) An information processing method including:
   recognizing a paired device that is paired with an autonomous mobile body;
   changing a control method for an output sound to be outputted from the autonomous mobile body, on the basis of a recognition result of the paired device; and
   controlling the output sound in accordance with the changed control method.
(17) A program for causing a computer to execute processes of:
   recognizing a paired device that is paired with an autonomous mobile body;
   changing a control method for an output sound to be outputted from the autonomous mobile body, on the basis of a recognition result of the paired device; and
   controlling the output sound in accordance with the changed control method.
(18) An information processing device including:
   a recognition section that recognizes a paired device that is paired with an autonomous mobile body; and
   a sound control section that changes a control method for an output sound to be outputted from the autonomous mobile body, on the basis of a recognition result of the paired device, and controls the output sound in accordance with the changed control method.

It is to be noted that the effects described in the present description are just examples, and thus, are not limitative. Any other effect may be provided.

### Reference Signs List

1: Information processing system
11: Autonomous mobile body
12: Information processing server
201: Control section
202: Sensor section
205: Sound output section
241: Information processing section
251: Recognition section
252: Action planning section
253: Motion control section
254: Sound control section
302: Recognition section
303: Action planning section
304: Motion control section
305: Sound control section

1. An autonomous mobile body comprising:
a recognition section that recognizes a paired device that is paired with the autonomous mobile body; and
a sound control section that changes a control method for an output sound to be outputted from the autonomous mobile body, on a basis of a recognition result of the paired device, and controls the output sound in accordance with the changed control method.

2. The autonomous mobile body according to claim 1, wherein
the recognition section further recognizes a condition of the autonomous mobile body, and
the sound control section controls the output sound on a basis of the condition of the autonomous mobile body.

3. The autonomous mobile body according to claim 2, wherein
the sound control section sets a reaction speed of the output sound when recognition of a predetermined condition is started, to be higher than a reaction speed of the output sound when the recognition of the predetermined condition is ended.

4. The autonomous mobile body according to claim 3, wherein
the sound control section promptly activates the output sound when the recognition of the predetermined condition is started, and gradually stops the output sound when the recognition of the predetermined condition is ended.

5. The autonomous mobile body according to claim 3, wherein
the predetermined condition includes a motion of the autonomous mobile body or a stimulus to the autonomous mobile body.

6. The autonomous mobile body according to claim 2, wherein
the recognition section recognizes conditions of the autonomous mobile body by respectively using multiple types of sensors, and
the sound control section changes the control method for the output sound on a basis of the type of the sensor used for recognizing the condition of the autonomous mobile body.

7. The autonomous mobile body according to claim 6, wherein
the sound control section controls the output sound by a control method corresponding to a characteristic of the sensor used for recognizing the condition of the autonomous mobile body.

8. The autonomous mobile body according to claim 1, wherein
the sound control section changes at least one of the output sound to be generated and an output timing of the output sound on the basis of the recognition result of the paired device.

9. The autonomous mobile body according to claim 8, wherein
the sound control section changes the output sound according to a type of the paired device that is paired with the autonomous mobile body.

10. The autonomous mobile body according to claim 8, wherein
the sound control section changes at least one of a pitch, a volume, a tone color, and a speed of the output sound.

11. The autonomous mobile body according to claim 1, wherein
the sound control section changes the control method for the output sound on a basis of a type of the recognized paired device.

12. The autonomous mobile body according to claim 1, wherein
the output sound includes a sound that is outputted in response to a motion of the autonomous mobile body or a sound that is outputted in response to a stimulus to the autonomous mobile body.

13. The autonomous mobile body according to claim 1, wherein
the recognition section recognizes the paired device on a basis of sensor data supplied from one or more types of sensors.

14. The autonomous mobile body according to claim 13, wherein
the recognition section recognizes the paired device on a basis of a motion change in the autonomous mobile body, and the motion change is recognized on a basis of the sensor data.

15. The autonomous mobile body according to claim 1, wherein
the paired device includes at least one of a part that is attachable to and detachable from the autonomous mobile body, a device that is attachable to and detachable from the autonomous mobile body, and a mobile body on which the autonomous mobile body is capable of being mounted.

16. An information processing method comprising:
recognizing a paired device that is paired with an autonomous mobile body;
changing a control method for an output sound to be outputted from the autonomous mobile body, on a basis of a recognition result of the paired device; and
controlling the output sound in accordance with the changed control method.

17. A program for causing a computer to execute processes of:
recognizing a paired device that is paired with an autonomous mobile body;
changing a control method for an output sound to be outputted from the autonomous mobile body, on a basis of a recognition result of the paired device; and
controlling the output sound in accordance with the changed control method.

18. An information processing device comprising:
a recognition section that recognizes a paired device that is paired with an autonomous mobile body; and
a sound control section that changes a control method for an output sound to be outputted from the autonomous mobile body, on a basis of a recognition result of the paired device, and controls the output sound in accordance with the changed control method.
